(19) United States
(12) Patent Application Publication
(10) Pub. No.: US 2009/0290921 A1
(43) Pub. Date: Nov. 26, 2009

(54) CLEANING BLADE FOR ELECTROPHOTOGRAPHIC APPARATUS

(75) Inventors: Kenichi Mochizuki, Ushiku-shi (JP); Sayaka Oonuki, Toride-shi (JP); Syouji Inoue, Ushiku-shi (JP)

Correspondence Address: FITZPATRICK CELLA HARPER & SCINTO, 1290 Avenue of the Americas, NEW YORK, NY, 10104-3800, US

(73) Assignee: CANON KASEI KABUSHIKI KAISHA, Tsukuba-shi (JP)

(21) Appl. No.: 12/463,014

(22) Filed: May 8, 2009

(30) Foreign Application Priority Data
May 22, 2008 (JP) 2008-134220

(51) Int. Cl. G03G 21/00

(52) U.S. Cl. 399/350

(57) ABSTRACT

There is provided a cleaning blade for an electrophotographic apparatus having good cleaning performance both immediately after long-time shutdown under low temperature environment and during continuous use under low temperature environment even when spherical toner having a small diameter is used. A cleaning blade for an electrophotographic apparatus having an elastic blade member which is brought into contact with an image bearing member and frictionally slid to remove remaining toner, wherein the elastic blade member satisfies (1) to (4): (1) the stress-relaxation rate represented by the formula (a) at 10° C. is 25% or less;

$$Stress \text{-} relaxation rate = \frac{\begin{matrix}Variation of stress when left to stand \\ at 10 \% stretching state for 1 hour\end{matrix}}{\begin{matrix}Stress at the moment of 10 \% \\ stretching\end{matrix}} \times 100 \qquad ( a )$$

(2) the international rubber hardness (IRHD) is 65 or more and 80 or less; (3) the stress upon 100% stretching in a tensile test is 3.0 MPa or more and 5.0 MPa or less; and (4) the peak tan δ temperature in a dynamic viscoelastic test is −20° C. or more and 0° C. or less.

### BACKGROUND OF THE INVENTION

1. Field of the Invention

The present invention relates to a cleaning blade used for an electrophotographic apparatus using an electrostatic transfer process such as an electrophotographic copier, a laser beam printer or a facsimile.

2. Description of the Related Art

In an electrophotographic apparatus represented by a copier, a printer, or a facsimile, toner is adhered to an electrostatic latent image which is formed by uniformly charging the outer peripheral surface of an image bearing member such as a photosensitive member and exposing the surface through an image to be copied, thereby forming a toner image, which is transferred to a transfer material such as paper to form an image. Since toner remains on the outer peripheral surface of a photosensitive member after transferring the toner image, a cleaning blade is brought into contact with the outer peripheral surface of the photosensitive member and frictionally slid to remove the remaining toner, thereby preparing for the next image formation.

A cleaning blade is disposed by integrating a rubber blade member at one end of a plate support fitting (holder) made of metal or the like and fixing the holder on an apparatus. Since the blade member is excellent in mechanical strength such as abrasion resistance and is low in creep property such as permanent deformation due to contact stress, a polyester-based urethane elastomer, especially a thermosetting polyester-based urethane elastomer is used.

A urethane elastomer is produced using a polyisocyanate, a polyol, a chain extender and a catalyst by a prepolymer method, a semi one-shot method, a one-shot method or the like. For example, when a cleaning blade is produced by a prepolymer method, the blade is produced by preparing a prepolymer using a polyisocyanate and a polyol, and adding a chain extender and a catalyst to this prepolymer, and then injecting the resulting prepolymer into a die for molding to cure.

In order to completely remove remaining toner on a photosensitive member by a cleaning blade, it is necessary that the contact of the cleaning blade with the outer peripheral surface of the photosensitive member is always maintained at a constant state. Therefore, the method in which the positional relationship between the cleaning blade and the photosensitive member is controlled or a support fitting is compressed by a spring is generally performed.

However, when the hardness of a blade made of a urethane elastomer is too high, the blade may damage a photosensitive member which is brought into contact with the blade, and when the hardness is too low, abrasion resistance becomes insufficient, and thereby chipping occurs on the edge portion of the blade and toner may pass through from the chipped portion of the blade to cause cleaning failure.

Due to high resolution of an electrophotographic apparatus in recent years, toner to be used has a smaller diameter and a spherical shape, and therefore toner easily passes through between a photosensitive member and a cleaning blade and cleaning failure easily occurs as compared with conventional electrophotographic apparatuses. Furthermore, along with the widespread use of electrophotographic copier and a laser beam printer, an electrophotographic apparatus has been used in broad environment as compared with the conventional one, and cleaning failure easily occurs due to reduction in rubber properties of a urethane elastomer used for a blade member especially under low temperature environment (10° C. or less). Particularly, cleaning failure easily occurs, especially when an electrophotographic apparatus is first used in the morning after being left to stand overnight under low temperature environment. It is reported that the cleaning performance at low temperatures has correlation with a peak tan δ temperature and can be improved by setting the peak tan δ temperature at or below the temperature assumed at the use temperature of an electrophotographic apparatus (Japanese Patent Application Laid-Open No. H11-212418). In addition, it is reported that the cleaning performance for spherical toner is improved by defining 300% modulus and tear strength (Japanese Patent Application Laid-Open No. 2002-72799). However, it cannot be said that the cleaning blade of Japanese Patent Application Laid-Open No. H11-212418 has sufficient cleaning performance for spherical toner having a small diameter along with high image quality of an electrophotographic apparatus, and it cannot be said that the cleaning blade of Japanese Patent Application Laid-Open No. 2002-72799 has sufficient cleaning performance under low temperature environment.

### SUMMARY OF THE INVENTION

An object of the present invention is to provide a cleaning blade for an electrophotographic apparatus having good cleaning performance both immediately after long-time shutdown under low temperature environment and during continuous use under low temperature environment even when spherical toner having a small diameter is used.

The present invention relates to a cleaning blade for an electrophotographic apparatus having an elastic blade member which is brought into contact with an image bearing member and frictionally slid to remove remaining toner, wherein the elastic blade member satisfies (1) to (4).

(1) the stress-relaxation rate represented by the formula (a) at 10° C. is 25% or less;

$$Stress \text{-} relaxation rate = \frac{\begin{matrix}Variation of stress when left to stand at 10 \% \\ stretching state for 1 hour\end{matrix}}{Stress at the moment of 10 \% stretching} \times 100 \qquad ( a )$$

(2) The international rubber hardness (IRHD) is 65 or more and 80 or less; (3) the stress upon 100% stretching in a tensile test is 3.0 MPa or more and 5.0 MPa or less; and (4) the peak tan δ temperature in a dynamic viscoelastic test is −20° C. or more and 0° C. or less.

The cleaning blade for an electrophotographic apparatus of the present invention has good cleaning performance both immediately after long-time shutdown under low temperature environment and during continuous use under low temperature environment even when spherical toner having a small diameter is used.

Further features of the present invention will become apparent from the following description of exemplary embodiments with reference to the attached drawings.

### BRIEF DESCRIPTION OF THE DRAWINGS

FIG. 1 is a side view illustrating an example of the cleaning blade for an electrophotographic apparatus of the present invention.

FIG. 2 is a schematic constitutional view illustrating an example of an electrophotographic apparatus which can apply the cleaning blade for an electrophotographic apparatus of the present invention.

### DESCRIPTION OF THE EMBODIMENTS

The cleaning blade for an electrophotographic apparatus of the present invention is a cleaning blade for an electrophotographic apparatus having an elastic blade member which is brought into contact with an image bearing member and frictionally slid to remove remaining toner, wherein the elastic blade member satisfies (1) to (4):

(1) the stress-relaxation rate represented by the formula (a) at 10° C. is 25% or less;

$$Stress \text{-} relaxation rate = \frac{\begin{matrix}Variation of stress when left to stand at 10 \% \\ stretching state for 1 hour\end{matrix}}{Stress at the moment of 10 \% stretching} \times 100 \qquad ( a )$$

(2) the international rubber hardness (IRHD) is 65 or more and 80 or less;
(3) the stress upon 100% stretching in a tensile test is 3.0 MPa or more and 5.0 MPa or less; and
(4) the peak tan δ temperature in a dynamic viscoelastic test is −20° C. or more and 0° C. or less.

The elastic blade member has (1) a stress-relaxation rate determined from the formula (a) at 10° C. of 25% or less. When the stress-relaxation rate represented by the formula (a) at 10° C. is 25% or less in the elastic blade member, the linear pressure in the edge portion of the elastic blade applied to the surface of a photosensitive member can be prevented from being decreased when left to stand for a long time under low temperature environment, and thereby cleaning failure can be prevented from occurring.

As a stress-relaxation rate, a value determined by the following method can be adopted. A strip specimen having a thickness of 0.5 mm is cut from the blade member fabricated and this specimen is fixed on a stress measuring apparatus (TMA/SS 6000: manufactured by Seiko Instruments Inc.) so that the measuring length is 10 mm. The environment in a cavity is set at 10° C. and the displacement of 1 mm is applied to the specimen to maintain for 60 minutes. The stress at the moment of applying the displacement and the stress after 60 minutes are measured, and the stress-relaxation rate is calculated from the measured values by the formula (a).

Further, the elastic blade member has (2) international rubber hardness (IRHD) of 65 or more and 80 or less. In the elastic blade member, when the hardness is 65° (IRHD) or more, toner can be prevented from being passed through, and when the hardness is 80° (IRHD) or less, a photosensitive member can be prevented from abrasion.

As an international rubber hardness (IRHD), a value measured using a hardness meter manufactured by H. W. WALLACE & Co., Ltd. by a measuring method according to JIS K6253 can be adopted.

Further, the elastic blade member has (3) a stress upon 100% stretching in a tensile test (M100) of 3.0 MPa or more and 5.0 MPa or less. In the elastic blade member, when M100 is 3.0 MPa or more, the linear pressure of the edge portion applied to the surface of a photosensitive member is sufficient, and thus deformation in the edge portion can be prevented, and toner can be prevented from being passed through and cleaning failure due to chipping of the edge portion can be prevented from occurring. When M100 is 5.0 PMa or less, the linear pressure of the edge portion applied to the surface of a photosensitive member can be prevented from excessively increasing, and abrasion in the edge portion or on the surface of a photosensitive member can be prevented from occurring.

As a stress upon 100% stretching in a tensile test, a value measured using a tensile tester (Unitron TS-3013: manufactured by Ueshima Seisakusho Co., Ltd.) by a measuring method according to JIS K6251 can be adopted.

Further, the elastic blade member has (4) a peak tan δ temperature in a dynamic viscoelastic test of −20° C. or more and 0° C. or less. When the peak tan δ temperature in a dynamic viscoelastic test is −20° C. or more, abrasion accompanied by extreme movement of the edge portion can be prevented, and when the peak temperature is 0° C. or less, the elastic blade member has sufficient elasticity during continuous use under low temperature environment, and thus can prevent occurrence of cleaning failure in low temperature environment.

As a peak tan δ temperature, a value measured by the following measuring method can be adopted. A strip specimen is cut from a blade member and this specimen is fixed on Dynamic Mechanical Spectrometer (DMS 6100: manufactured by Seiko Instruments Inc.) so that the measuring length is 20 mm. The specimen is subjected to distortion at an amplitude of 5 μm and a frequency of 10 Hz, and tan δ of −30° C. to 60° C. is measured every about 0.5° C. at a rate of temperature rise of 2° C./min. The temperature at which the value of tan δ is maximum is taken as a peak tan δ temperature.

The elastic blade member satisfies (1) to (4), and thereby has good cleaning performance under low temperature environment even when spherical toner having a small diameter is used.

The elastic blade member can be one formed using a urethane elastomer material.

Such a urethane elastomer material can be a liquid composition containing a polyisocyanate, a polyol, a chain extender and a urethane curing catalyst.

The polyisocyanate may be any one as long as it has two or more isocyanate groups and examples thereof include the following: 4,4′-diphenyl methane diisocyanate (MDI), isophorone diisocyanate and 4,4′-dicyclohexyl diisocyanate; trimethylhexamethylene diisocyanate, tolylene diisocyanate, carbodiimido-modified diisocyanate and polymethylene phenyl polyisocyanate; and ortho-toluidine diisocyanate, naphthalene diisocyanate, xylene diisocyanate, hexamethylene diisocyanate, para-phenylene diisocyanate, lysine diisocyanate methyl ester and dimethyl diisocyanate. These may be used alone or in combination of two or more kinds. Among them, 4,4′-diphenyl methane diisocyanate (MDI) can be particularly used.

The polyol used with the polyisocyanate may be any one as long as it has two or more hydroxyl groups and examples thereof include the following: polyethylene adipate polyester polyol, polybutylene adipate polyester polyol, polyhexylene adipate polyester polyol and polyethylene-propylene adipate polyester polyol; adipate-based polyester polyols such as polyethylene-butylene adipate polyester polyol and polyethylene-neopentylene adipate polyether polyol; polycaprolactone-based polyester polyols obtained by ring-opening polymerizing caprolactone and polyether polyols such as polyethylene glycol, polypropylene glycol and polytetramethylene glycol; and polycarbonate diols. These may be used alone or in combination of two or more kinds.

The chain extender may be any one as long as it can extend a urethane elastomer chain and a polyol can be used. Specifically, examples thereof include the following: 1,4-butanediol, ethylene glycol, diethylene glycol, propylene glycol, dipropylene glycol, hexane diol, 1,4-cyclohexane diol, 1,4-cyclohexane dimethanol and xylylene glycol; and polyols having a molecular weight of 200 or less such as triethylene glycol, trimethylol propane, glycerine, pentaerythritol, sorbitol and 1,2,6-hexane triol.

The urethane curing catalyst is divided broadly into an isocyanuration catalyst and an urethanization catalyst, and one of them may be used, but an isocyanuration catalyst and an urethanization catalyst can be used in combination. As the urethane curing catalyst, amine-based compounds such as a tertiary amine and organic metal compounds can be used. Specifically, examples thereof include the following. Examples of the isocyanuration catalyst include tertiary amines such as N-ethylpiperidine, N,N′-dimethylpiperadine and N-ethylmorpholine; hydroxides and weak organic acid salts of tetraalkyl ammoniums such as tetramethyl ammonium, tetraethyl ammonium and tetrabutyl ammonium; hydroxides and weak organic acid salts of hydroxyalkyl ammoniums such as trimethylhydroxypropyl ammonium and triethylhydroxypropyl ammonium; and alkali metal salts of carboxylic acids such as acetic acid, propionic acid, butyric acid, caproic acid, capric acid, valeric acid, octylic acid, myristic acid and naphthenic acid. These may be used alone or in combination of two or more kinds. Among them, alkali metal salts of carboxylic acids can prevent bloom after molding and contamination of other parts, and thus is preferred.

As the urethanization catalyst, a polyurethane curing catalyst generally used can be used and examples thereof include a tertiary amine catalyst: amino alcohols such as dimethylethanolamine and N,N,N′-trimethylaminopropylethanolamine; trialkylamines such as triethylamine; tetraalkyldiamines such as N,N,N′,N′-tetramethyl-1,3-buthanediamine; and triethylenediamine, piperadine-based catalyst and triadine-based catalyst. In addition, a metal catalyst used for molding of polyurethane may be used and examples thereof include dibutyl tin dilaurate. These may be used alone or in combination of two or more kinds. Among them, amino alcohols are preferred because they can prevent bloom after molding and contamination of other parts together with reactivity, and N,N-dimethylaminohexanol is further preferred.

The amount of an isocyanuration catalyst used can be 0.01% by mass or less based on the total mass of a polyol and a polyisocyanate. When the amount of an isocyanuration catalyst used is 0.01% by mass or less, the amount of isocyanate becomes large, and thereby the stress-relaxation rate can be prevented from excessively increasing.

The amount of a polyol can be 150 parts by mass or more and 300 parts by mass or less and the amount of a chain extender can be 10 parts by mass or more and 20 parts by mass or less based on 100 parts by mass of polyisocyanate in the urethane elastomer material. In addition, the amount of a urethane curing catalyst used can be 0.02% by mass or more and 0.05% by mass or less based on the total mass of a urethane elastomer material.

Additives such as a catalyst, a pigment, a plasticizer, a water-proofing agent, an antioxidant, an ultraviolet absorber and a light stabilizer can be blended if necessary in the urethane elastomer material.

In order to produce an elastic blade member using such a urethane elastomer material, a prepolymer method, a one-shot method, a semipolymer method, a pseudo-prepolymer method or the like can be used. As an example thereof, the molding method for applying a prepolymer method will be described below.

Firstly, a molding die for a cleaning blade is prepared, and a holder serving as a support member is disposed. Next, a prepolymer which is partially polymerized in advance by mixing a polyisocyanate and a polyester polyol, a urethane curing catalyst and a chain extender are charged into a casting machine, and stirred in a mixing chamber to obtain a liquid mixture. This mixture is injected into the molding die and reacted for curing, and then the cured product is removed from the die and cut into a predetermined size, and thereby a cleaning blade in which an elastic blade member made of polyurethane elastomer is molded on the holder can be produced. An adhesive can be applied to a portion for molding the elastic blade member of the holder.

In the above method, a method for molding an elastic blade member in which a holder is disposed on a molding die has been described, but it is also possible that an elastic blade member is molded without disposing a holder on a molding die and then the resulting blade member is adhered to a holder.

In an elastic blade member obtained from the urethane elastomer material,

(5) the polyisocyanate concentration can be 0.95 mmol/g or more and 1.15 mmol/g or less;
(6) the chain extender concentration can be 0.25 mmol/g or more and 0.50 mmol/g or less; and
(7) the urethane group concentration can be 1.50 mmol/g or more and 1.80 mmol/g or less.

When an elastic blade member has (5) the polyisocyanate concentration of 0.95 mmol/g or more, the amount of hard segments in a urethane elastomer is sufficient, and thereby softening can be prevented and the above conditions of (1) to (4) are satisfied. On the other hand, when the polyisocyanate concentration is 1.15 mmol/g or less, the amount of hard segments is excessively large, and thereby high hardness can be prevented and the above conditions of (1) to (4) are satisfied.

When an elastic blade member has (6) the chain extender concentration of 0.25 mmol/g or more, the amount of hard segments in a urethane elastomer is sufficient, and thereby softening can be prevented and the above conditions of (1) to (4) are satisfied. On the other hand, when the chain extender concentration is 0.50 mmol/g or less, the amount of hard segments is excessively large, and thereby high hardness can be prevented and the above conditions of (1) to (4) are satisfied.

When an elastic blade member has (7) the urethane group concentration of 1.50 mmol/g or more, agglomeration between molecular chains is sufficient, and thereby softening can be prevented and the above conditions of (1) to (4) are satisfied. On the other hand, when the urethane group concentration is 1.80 mmol/g or less, agglomeration between molecular chains is excessively large, and thereby high hardness can be prevented and the above conditions of (1) to (4) are satisfied.

The polyisocyanate concentration and the chain extender concentration in the blade member can be determined by the following formulas (b) and (c) by calculating the number of moles from each of the charged amounts (g) and the molecular weights. In addition, the urethane group concentration can be determined by the following formula (d) from the number of hydroxyl group of each of a polyol and a chain extender determined by the following formulas (e) and (f). As the hydroxyl value of polyol, the measured value obtained by a measuring method according to JIS K1557-1 can be adopted.

$$\begin{matrix}Polyisocyanate concentration = \frac{Number of mmol of polyioscyanate ( mmol )}{Mass of balde member ( g )} & ( b ) \\ Chain extender concentration = \frac{Number of mmol of chain extender ( mmol )}{Mass of blade member ( g )} & ( c ) \\ Urethane group concentration = \frac{\begin{matrix}Number of hydroxyl group of polyol + \\ Number of hydroxyl group of chain extender ( mmol )\end{matrix}}{Mass of blade member ( g )} & ( d ) \\ Number of hydroxyl group of polyol = \frac{Amount of polyol charged ( g ) \times Hydroxyl value of polyol}{56.11} & ( e ) \\ Number of hydroxyl group of chain extender = \frac{\begin{matrix}Amount of chain extender charged ( g ) \times \\ Number of functional group\end{matrix}}{Molecular weight of chain extender} & ( f )\end{matrix}$$

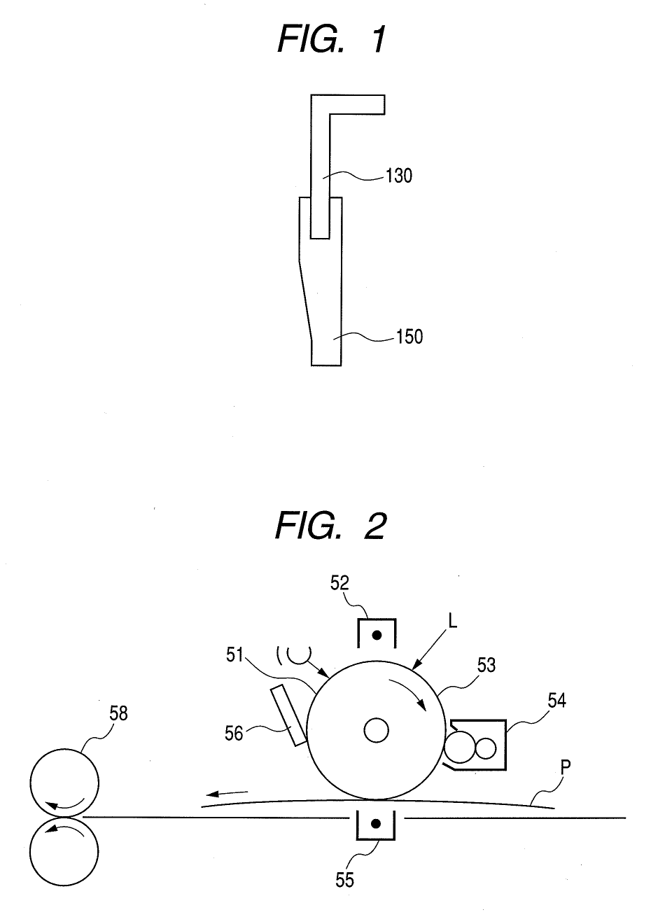

An example of the cleaning blade for an electrophotographic apparatus of the present invention is illustrated in FIG. 1. In the cleaning blade for an electrophotographic apparatus illustrated in FIG. 1, a blade member 150 of the present invention is mounted on a holder made of metal (rigid plate body) 130. Moreover, the position of a blade member formed in the cleaning blade for an electrophotographic apparatus and the shape can be appropriately selected so that the blade member can be brought into contact with a photosensitive drum.

The cleaning blade for an electrophotographic apparatus of the present invention is used, for example, for an electrophotographic apparatus using an electrostatic transfer process such as a copier, a laser beam printer, an LED printer, a facsimile and an electrophotomechanical system. Moreover, a plurality of members such as an image bearing member, a charging member and a developing member other than a cleaning blade is integrally incorporated into these apparatuses and can be applied as a process cartridge detachable to the main body of the electrophotographic apparatus.

An example of an electrophotographic apparatus for applying the cleaning blade for an electrophotographic apparatus of the present invention includes an electrophotographic apparatus illustrated in FIG. 2. In the image forming apparatus illustrated in FIG. 2, an image bearing member 51 such as a photosensitive member is rotationally driven at a predetermined peripheral speed around a spindle in a clockwise direction on the figure. The surface of this image bearing member 51 is uniformly subjected to charging treatment by a charging member 52 such as a corona discharger and a charging roller so as to have predetermined polarity and potential. Next, the surface of the image bearing member 51 uniformly subjected to charging treatment is subjected to exposure of objective image information (laser beam scanning exposure, slit exposure of original image and the like) by an exposure unit L, and thereby an electrostatic latent image 53 corresponding to the objective image information is formed. Thereafter, the electrostatic latent image 53 is sequentially converted into a visible image as a toner image by a developing member 54.

A toner image formed on the surface of the image bearing member 51 is then transferred to the surface side of a transfer material P by a transfer member 55. Moreover, the transfer material P is conveyed to a transfer portion between the image bearing member 51 and the transfer member 55 at an appropriate timing by being synchronized with the rotation of the image bearing member 51 from a paper feed unit not illustrated in the figure. The transfer member 55 may be a roller type. In addition, in a color LBP which outputs a color image using four color toners, a color image of each color is sequentially superimposed and transferred to an intermediate transfer body such as a roller or a belt, and then transferred to the surface side of the transfer material P. The transfer material P subjected to transfer of the toner image is separated from the image bearing member 51 and is subjected to image fixation by a fixing member 58 such as a heat fixing roller and is output as an image formation product.

After transfer, the surface of the image bearing member 51 is made to have a clean surface by removing adhered contamination such as remaining toner by the cleaning blade for an electrophotographic apparatus 56 of the present invention and is repeatedly prepared for forming an image.

### EXAMPLES

Next, the cleaning blade for an electrophotographic apparatus of the present invention will be described in detail by way of examples, but the technical scope of the present invention is not intended to be limited to these examples.

### Example 1

### Preparation of Urethane Elastomer Material

(A) 4,4′-Diphenyl methane diisocyanate (MDI) and (B) polybutylene adipate polyester polyol (PBA, number average molecular weight 2000) were mixed at a ratio shown in Table 1, and reacted at 80° C. for 120 minutes under nitrogen atmosphere to obtain a prepolymer. On the other hand, (C) 1,4-butanediol (1,4-BD) and trimethylol propane (TMP), (D) polyhexylene adipate polyester polyol (PHA, number average molecular weight 1000) and (E) a catalyst were mixed at a ratio shown in Table 1 to obtain a curing agent.

The molecular weights of the prepolymer and a polyol in the curing agent were determined by the following method. For monodispersion polystyrene for gel permeation chromatography (GPC), a calibration curve of the peak count number and number average molecular weight of the monodispersion polystyrene was made using GPC under the following conditions. Column: G3000PWXL×2 (manufactured by Tosoh Corporation); Elution solvent: 20 mM Phosphate buffer; Detector: Differential refractometer; Flow rate: 0.5 mL/min; Amount of sample solution used: 10 μL; and Column temperature: 45° C. The average molecular weights were calculated from the determined calibration curve.

(Production of Cleaning Blade for Electrophotographic Apparatus)

A holder was previously prepared as a support member and an adhesive was applied to the one end surface. The holder was disposed on a molding die for a cleaning blade including an upper die and a lower die in a state where the one end portion having an adhesive applied protruded into a cavity, and the prepared urethane elastomer material was injected into the inside of the cavity. This was reacted and cured at a heating temperature of 130° C., and then the cured product was removed from the die and cut into a predetermined size, and thereby a cleaning blade for an electrophotographic apparatus in which an elastic blade member is molded on a holder was fabricated.

The stress-relaxation rate, hardness, 100% modulus in a tensile test, and the peak tan δ temperature for the obtained cleaning blade were measured by the above method. The results are shown in Table 3.

TABLE 1

| | | | Example 1 | Example 2 | Example 3 | Example 4 |
|---|---|---|---|---|---|---|
| Prepolymer | Isocyanate | Type | MDI | MDI | MDI | MDI |
| | | Number of | 27.0 | 28.7 | 28.2 | 25.6 |
| | | parts | | | | |
| | Polyol | Type | PBA | PBA | PBA | PBA |
| | | Average | 2000 | 2000 | 2000 | 2000 |
| | | molecular | | | | |
| | | weight | | | | |
| | | Number of | 56.7 | 54.7 | 66.8 | 57.1 |
| | | parts | | | | |
| Curing | Chain | 1,4-BD | 2.1 | 2.2 | 3.0 | 2.3 |
| agent | extender | TMP | 1.8 | 1.8 | 2.0 | 1.9 |
| | Polyol | Type | PHA | PHA | — | PHA |
| | | Average | 1000 | 1000 | — | 1000 |
| | | molecular | | | | |
| | | weight | | | | |
| | | Number of | 12.4 | 12.6 | — | 13.1 |
| | | parts | | | | |
| | Catalyst | Isocyanuration | 0.003 | 0.007 | 0.002 | 0.004 |
| | | catalyst | | | | |
| | | Urethanization | 0.034 | 0.028 | 0.025 | 0.036 |
| | | catalyst | | | | |

TABLE 2

| | | | Comparative | Comparative | Comparative |
|---|---|---|---|---|---|
| | | | Example 1 | Example 2 | Example 3 |
| Prepolymer | Isocyanate | Type | MDI | MDI | MDI |
| | | Number of | 30.4 | 30.1 | 28.1 |
| | | parts | | | |
| | Polyol | Type | PBA | PBA | PBA |
| | | Average | 2000 | 2000 | 2000 |
| | | molecular | | | |
| | | weight | | | |
| | | Number of | 54.6 | 64.7 | 66.7 |
| | | parts | | | |
| Curing agent | Chain | 1,4-BD | 2.0 | 3.3 | 3.1 |
| | extender | TMP | 1.6 | 1.8 | 2.1 |
| | Polyol | Type | PHA | — | — |
| | | Average | 1000 | — | — |
| | | molecular | | | |
| | | weight | | | |
| | | Number of parts | 11.5 | — | — |
| | Catalyst | Isocyanuration | 0.006 | 0.004 | 0.003 |
| | | catalyst | | | |
| | | Urethanization | 0.026 | 0.026 | 0.026 |
| | | catalyst | | | |

The unit of values in tables is parts by mass and the symbols indicate the following.

MDI: 4,4′-Diphenyl methane diisocyanate (Millionate MT: produced by Nippon Polyurethane Industry Co., Ltd.)
PBA: Polybutylene adipate polyester polyol (Nipporan 4010: produced by Nippon Polyurethane Industry Co., Ltd.)
1,4-BD: 1,4-Butanediol (produced by Mitsubishi Chemical Corporation)
TMP: Trimethylol propane (produced by Mitsubishi Gas Chemical Company, Inc.)
PHA: Polyhexylene adipate polyester polyol (Nipporan 164: produced by Nippon Polyurethane Industry Co., Ltd.)
Urethanization catalyst (Kaolizer No. 25: Kao Corporation)
Isocyanuration catalyst (P15: Air Products Japan, Inc.)

(Actual Machine Evaluation)

The obtained cleaning blade for an electrophotographic apparatus was incorporated into a laser beam printer (LBP-2510: manufactured by Canon Inc.), and evaluations for cleaning properties after long-time shutdown and cleaning properties in 500 continuous image formation (30%) at a low temperature (10° C.) were performed. When an image failure due to cleaning failure was not observed, the result was expressed as A, when slight image failure was observed, the result was expressed as B, and when significant image failure was observed, the result was expressed as C. The results are shown in Table 3.

### Examples 2 to 4 and Comparative Examples 1 to 3

A cleaning blade for an electrophotographic apparatus was fabricated in the same manner as in Example 1 except that a prepolymer and a curing agent were used at a ratio shown in Tables 1 and 2, and was evaluated. The results are shown in Tables 3 and 4.

TABLE 3

| | | Example 1 | Example 2 | Example 3 | Example 4 |
|---|---|---|---|---|---|
| (1) Stress-relaxation | | 7% | 15% | 8% | 6% |
| rate (%) | | | | | |
| (2) Hardness (IRHD) | | 71° | 72° | 73° | 70° |
| (3) M100 (MPa) | | 3.7 | 4.3 | 3.1 | 3.5 |
| (4) Peak tan δ | | −10° C. | −7° C. | −4° C. | −11° C. |
| temperature | | | | | |
| (5) Polyisocyanate | | 1.08 | 1.15 | 1.13 | 1.02 |
| concentration (mmol/g) | | | | | |
| (6) Chain extender | | 0.37 | 0.38 | 0.48 | 0.39 |
| concentration (mmol/g) | | | | | |
| (7) Urethane group | | 1.68 | 1.68 | 1.78 | 1.75 |
| concentration (mmol/g) | | | | | |
| Results of | After | A | A | A | A |
| image | long-time | | | | |
| evaluation | shutdown | | | | |
| | After | A | A | A | A |
| | printing | | | | |
| | 500 sheets | | | | |

TABLE 4

| | | Comparative | Comparative | Comparative |
|---|---|---|---|---|
| | | Example 1 | Example 2 | Example 3 |
| (1) Stress-relaxation | | 30% | 22% | 15% |
| rate (%) | | | | |
| (2) Hardness (IRHD) | | 74° | 73° | 70° |
| (3) M100 (MPa) | | 5.1 | 3.9 | 2.8 |
| (4) Peak tan δ | | −8° C. | 2° C. | 0° C. |
| temperature | | | | |
| (5) Polyisocyanate | | 1.21 | 1.20 | 1.12 |
| concentration (mmol/g) | | | | |
| (6) Chain extender | | 0.34 | 0.51 | 0.50 |
| concentration (mmol/g) | | | | |
| (7) Urethane group | | 1.58 | 1.79 | 1.82 |
| concentration (mmol/g) | | | | |
| Results of | After | C | B | B |
| image | long-time | | | |
| evaluation | shutdown | | | |
| | After | B | B | B |
| | printing | | | |
| | 500 sheets | | | |

As shown in Tables 3 and 4, in Examples 1 to 4, cleaning failure did not occur after long-time shutdown and after reproducing 500 sheets. On the contrary, in Comparative Example 1, sufficient contact pressure could not be obtained after long-time shutdown at low temperatures due to a large stress-relaxation rate, and thereby cleaning failure occurred. Moreover, M100 in a tensile test was larger than 5.0 MPa, and therefore image failure occurred due to scraping the surface of a photosensitive member drum. In Comparative Example 2, the peak tan δ temperature was high, and therefore rubber properties at low temperatures were insufficient and cleaning failure occurred. In addition, in Comparative Example 3, the value of M100 in a tensile test was 3.0 MPa or less, and therefore contact pressure necessary for cleaning could not be obtained and cleaning failure occurred.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-134220, filed May 22, 2008, which is hereby incorporated by reference herein in its entirety.

What is claimed is:

1. A cleaning blade for an electrophotographic apparatus having an elastic blade member which is brought into contact with an image bearing member and frictionally slid to remove remaining toner,
wherein the elastic blade member satisfies (1) to (4):
(1) the stress-relaxation rate represented by the formula (a) at 10° C. is 25% or less;
$$Stress \text{-} relaxation rate = \frac{\begin{matrix}Variation of stress when left to stand at 10 \% \\ stretching state for 1 hour\end{matrix}}{Stress at the moment of 10 \% stretching} \times 100 \qquad ( a )$$
(2) the international rubber hardness (IRHD) is 65 or more and 80 or less;
(3) the stress upon 100% stretching in a tensile test is 3.0 MPa or more and 5.0 MPa or less; and
(4) the peak tan δ temperature in a dynamic viscoelastic test is −20° C. or more and 0° C. or less.

2. The cleaning blade for an electrophotographic apparatus according to claim 1 wherein the elastic blade member is formed using a urethane elastomer material.

3. The cleaning blade for an electrophotographic apparatus according to claim 2 wherein the elastic blade member satisfies (5) to (7):
(5) the polyisocyanate concentration is 0.95 mmol/g or more and 1.15 mmol/g or less;
(6) the chain extender concentration is 0.25 mmol/g or more and 0.50 mmol/g or less; and
(7) the urethane group concentration is 1.50 mmol/g or more and 1.80 mmol/g or less.

4. The cleaning blade for an electrophotographic apparatus according to claim 3 wherein the polyisocyanate is 4,4′-diphenyl methane diisocyanate.
